(19) United States
(12) Patent Application Publication
(10) Pub. No.: US 2007/0230968 A1
(43) Pub. Date: Oct. 4, 2007

(54) Optical transmission apparatus

(75) Inventor: Yoshihiro Shimizu, Kawasaki (JP)

Correspondence Address: BINGHAM MCCUTCHEN LLP, 2020 K Street, N.W., Intellectual Property Department, WASHINGTON, DC, 20006, US

(73) Assignee: Fujitsu Limited

(21) Appl. No.: 11/513,260

(22) Filed: Aug. 31, 2006

(30) Foreign Application Priority Data
Mar. 31, 2006 (JP) 2006-099144

(51) Int. Cl. H04B 10/00

(52) U.S. Cl. 398/177

(57) ABSTRACT

In an optical transmission apparatus, a number of wavelengths of an output light to an optical transmission line and an optical power of each of the wavelengths are detected by a spectrum analyzer, and a power of a super continuum light outputted to a highly nonlinear fiber is controlled by a controller so as to confine the number of wavelengths and the optical power within predetermined ranges. A wavelength component corresponding to a signal light is removed by a filter from the output light from the highly nonlinear fiber, and an output light of the filter and the signal light is coupled by an optical coupler.

### BACKGROUND OF THE INVENTION

1. Field of the Invention

The present invention relates to an optical transmission apparatus, and in particular to an optical transmission apparatus performing a long-distance transmission of an optical signal of a plurality of wavelengths by a wavelength division multiplexing (WDM).

2. Description of the Related Art

FIG. 13 shows an example of a previously known wavelength division multiplexing optical transmission apparatus In this prior art example, as shown in a portion (a) of FIG. 13, a wavelength multiplexer (MUX) 20 having received a signal light from a transmitting transponder (TXP) 10 provided per channel ch1 . . . multiplexes wavelengths of the signal light to be transmitted to an optical transmission line.

In the optical transmission line, as shown in FIG. 13, erbium-doped fiber amplifiers (hereinafter, occasionally abbreviated as EDFA) 11-15 are serially connected. Distributed Raman amplifiers (hereinafter, occasionally abbreviated as DRAs) 21-24 are respectively connected to the output terminals of the EDFAs 11-14. Thus, the EDFAs 11-15 perform an auto level control (ALC) for maintaining a total power (see a portion (b) of FIG. 13) of the signal light and an amplified spontaneous emission (ASE) light of the output signal lights OS1-OS5. It is to be noted that the ASE light is spontaneously emitted by the wavelength multiplexing transmission apparatus of a multiple span (multiple stage optical amplification) type using the Raman amplifiers 21-24 as described above. Also, the ALC level is assumed to be an output level (fixed) per wave×the number of wavelengths.

Thus, on the receiving side of the optical transmission line, a demultiplexer (DMUX) 30, having received the signal light OS5 which is constantly controlled to have a fixed optical power, demultiplexes the signal light to be outputted to a receiving transponder (RXP) 40 provided per channel.

Noting that in an optical add-drop system, when an optical signal transmitted from a branch station and an optical signal transmitted from a terminal station are coupled by a branching unit, an S/N ratio of the optical signal whose optical power is lower is deteriorated when the optical power levels are different from each other, worsening the system performance, there has been known an optical communication system that adjusts the power levels of the optical signals by transmitting a dummy light together with the optical signal from the branch station, or adjusts the levels of both of the added optical signals to be equalized, when optical signals are added, by providing a branching unit with an optical attenuator or an active optical signal level adjusting apparatus (see e.g. patent document 1).

Also, there have been known an optical transmission system and an optical transmission apparatus in which an optical transmission terminal station is provided with an array waveguide grating (AWG) capable of multiplexing signal lights with wavelengths. Output signal lights from optical transmitters are respectively inputted to input ports for channels of the AWG. Output lights from optical amplifiers that receive no input light are respectively inputted as a dummy light to input ports for channels of the AWG. The AWG multiplexes the input lights of the channels, so that the multiplexed light is inputted to an optical amplifier of an optical reception terminal station through an optical amplifier and an optical fiber transmission line. The optical amplifier amplifies the light from the optical fiber transmission line to be applied to an AWG which demultiplexes the output light from the optical amplifier into wavelength components of the channels. Output lights from the channels of the AWG are respectively inputted to optical receivers (see e.g. patent document 2).

Also, there have been known an optical transmission method and an optical transmission apparatus in which the transmission wavelength band of an optical transmission line designed for wavelength division multiplexing is segmented into a plurality of sub-bands, a signal light or an ASE dummy light is transmitted using a sub-band as a transmission unit, and the ASE dummy light is assigned to a plurality of sub-bands so that a gain profile according to the design of the optical transmission line is satisfied (see e.g. patent document 3).

Moreover, there have been known an optical transmitter, a wavelength multiplexing optical transmitter, and an optical transmission method in which wavelengths and levels of signal lights transmitted from optical transmitters are constantly monitored, so that when an abnormality is detected, a continuous light of the same wavelength and the same level as those of the above-mentioned optical signal at normal times is transmitted from a standby light source, thereby avoiding an interference with an adjoining signal light and level changes of other signal lights (see e.g. patent document 4).

[Patent document 1] Japanese patent application laid-open No. 10-150433

[Patent document 2] Japanese patent application laid-open No. 2002-51008

[Patent document 3] Japanese patent application laid-open No. 2005-51596

[Patent document 4] Japanese patent application laid-open No. 11-284574

In a wavelength multiplexing optical transmission apparatus using the Raman amplifiers 21-24 as shown in FIG. 13, in the presence of a small number of wavelengths such as only channel ch1 as shown in the portion (b) of FIG. 13, a noise component of the spontaneously emitted ASE light 200 in contrast to the main signal light 100 of the channel ch1 exists, so that when this noise component is transmitted through the optical transmission line of multiple spans, an amplified spontaneous Raman scattering (ASS) light 210 is generated as shown in a portion (c) of FIG. 13, thereby causing a problem that the optical SN ratio on the receiving side is deteriorated.

As a countermeasure, an optical amplifier output level of each span is increased for the ASE light 200 in operation of the small number of wavelengths, so that an ASE compensation control for avoiding a decrease of the signal light is performed as shown in a portion (d) of FIG. 13. In this case, however, each of the EDFAs 11-15 calculates an output compensation amount of itself based on an output compensation amount of a preceding stage to be reflected to the output. Therefore, when the number of stages of the EDFAs is increased, there has been a problem that the initial start-up takes time.

Also, as shown in FIG. 14A, in the presence of a large number of wavelengths, the ratio of the ASE light+ASS light to the signal light OS is low. When the transmission apparatus performs the compensation control, namely, when the optical signal OS is lost even in the presence of an error between the noise light (see a portion (a1) of FIG. 14A) estimated by the transmission apparatus and the noise light (see a portion (a2) of FIG. 14A) actually generated on the transmission line, a possibility of the noise light exceeding the signal light disconnection detecting threshold Th1 is low. Therefore, there is a low possibility of erroneously detecting a loss of signal light, i.e. main signal disconnection.

On the contrary, in the presence of a small number of wavelengths as shown in FIG. 14B, the ratio of the ASE light+ASS light to the signal light OS becomes high. Even if an error of the optical power between the noise light (see a portion (b1) of FIG. 14B) estimated within the transmission apparatus and the noise light (see a portion (b2) of FIG. 14B) actually generated on the transmission line is the same as that in case of a large number of wavelengths depending on the operational condition, when the signal light OS assumes an input disconnection state, the optical power of the ASE light+ASS light does not assume lower than the signal light disconnection detecting threshold Th2, so that the disconnection state of the signal light cannot be detected, thereby disabling an operation of the automatic power shutdown (APSD).

Namely, even if fiber types are the same, the conditions of the transmission line observed from the Raman amplifier (loss coefficient, local loss, etc.) differ between the initially measured data and the actual transmission line. Specifically in the presence of a small number of wavelengths as shown in FIG. 14B, the output control of the laser diode is performed under a condition where the ASS light generation amount is not sufficiently small compared to the signal light level in some cases. Therefore, the accuracy of the signal disconnection detection and the accuracy of the total power control have been significantly deteriorated. Along with this, there is an operation state where the ASS light amount becomes large compared to the signal disconnection detecting threshold. Therefore, in some cases the signal disconnection detecting threshold becomes inadequate depending on operation conditions, so that the ASS light does not assume lower than the threshold even when the signal input is disconnected, and the signal disconnection is not detected, thereby disabling the automatic power shutdown control.

### SUMMARY OF THE INVENTION

It is accordingly an object of the present invention to provide an optical transmission apparatus capable of normally detecting a signal light disconnection even in the presence of a small number of wavelengths, thereby improving the speed and the stability at the time of the initial start-up of the apparatus.

In order to achieve the above-mentioned object, an optical transmission apparatus according to one aspect of the present invention comprises: a spectrum analyzer detecting a number of wavelengths of an output light to an optical transmission line and an optical power of each of the wavelengths; a controller controlling an optical power outputted from a source of a super continuum light so as to confine the number of wavelengths and the optical power within predetermined ranges; a filter removing a wavelength component corresponding to a signal light from the super continuum light; and a coupler coupling an output light of the filter and the output light to the optical transmission line.

A principle of such an optical transmission apparatus will now be described referring to FIG. 1.

An optical transmission system shown in a portion (a) of FIG. 1 is the same as the prior art example shown in the portion (a) of FIG. 13. In this optical transmission system, arrangements are added by inserting an optical coupler 50 between a wavelength multiplexer 20 and an EDFA 11 on the transmission side, so that a dummy light 400 is generated by a spectrum analyzer 80, a controller 81, and a filter 70 to be inserted into the optical coupler 50.

Namely, the spectrum analyzer 80 as a measurement means of optical power corresponding to a wavelength is connected to the output side of the EDFA 11, so that the number of wavelengths in the output light of the EDFA 11 and the optical power of each of the wavelengths are detected by the spectrum analyzer 80 to be transmitted to the controller 81. The controller 81 includes a super continuum (SC) light source 60, which further includes a highly nonlinear fiber (not shown). A super continuum light (hereinafter, occasionally referred to simply as SC light) 300 is provided to the filter 70 from the highly nonlinear fiber. The controller 81 controls the output optical power of the super continuum light 300 from the SC light source 60 so as to confine the number of wavelengths and the optical power of each of the wavelengths detected by the spectrum analyzer 80 within predetermined ranges.

As a result, an optical power exists throughout a wide wavelength bandwidth in the SC light 300 from the SC light source 60 as shown in (b) of FIG. 1. The filter 70 separates the SC light 300 into wavelength components to remove therefrom the main signal light provided from the wavelength multiplexer 20. For example, a portion (bandwidth) corresponding to the signal light of a channel ch1 in the portion (a) of FIG. 1 is removed, so that a dummy light 400 as shown in a portion (c) of FIG. 1 is generated to be provided to the optical coupler 50.

As a result, as shown in a portion (d) of FIG. 1, the output light from the EDFA 11 includes the main signal light (ch1) 100 and the dummy light 400. Therefore, when such an output light is transmitted through the transmission line and then outputted by the EDFA 15 to the receiving side, the main signal light 100 assumes a state as shown in a portion (e) of FIG. 1 where the optical SN ratio to the ASE light+ASS light is not deteriorated due to the presence of the dummy light 400. In other words, although the signal light to be transmitted has a single wavelength (ch1), that is a small number of wavelengths, the transmitted light has a large number of wavelengths as shown in the portion (d) of FIG. 1 due to the dummy light, thereby assuming the state of FIG. 14A, so that the deterioration of the optical SN ratio is suppressed and the main signal disconnection can be detected without fail.

The above-mentioned controller may comprise a highly nonlinear fiber, a mode-locked fiber laser generating the super continuum light by providing an optical pulse to the highly nonlinear fiber, and a pumping light generator providing the mode-locked fiber laser with a pumping light through an optical coupler based on the number of wavelengths and the optical power.

Namely, the output wavelength bandwidth corresponding to the number of wavelengths and the optical power of the super continuum light are controlled by controlling the power of the pumping light for the mode-locked fiber laser, thereby enabling the pumping light corresponding to the number of wavelengths and the optical power to be provided as the dummy light 400 to the optical coupler 50.

Alternatively, the above-mentioned controller may comprise a highly nonlinear fiber, a mode-locked fiber laser of a fixed optical power outputting type generating the super continuum light of a fixed optical power by providing an optical pulse to the highly nonlinear fiber, an erbium-doped fiber connected between the mode-locked fiber laser and the highly nonlinear fiber, and a pumping light generator providing the erbium-doped fiber with a pumping light through an optical coupler based on the number of wavelengths and the optical power.

In this case, a fixed optical output power of the mode-locked fiber laser is used, and the power of the pumping light for the light outputted from the mode-locked fiber laser to the erbium-doped fiber is controlled, thereby enabling a larger number of wavelengths of the dummy light 400 to be generated and provided to the optical coupler 50.

Moreover, the above-mentioned pumping light generator may comprise a plurality of laser diodes, a selector selecting at least one from among the laser diodes based on the number of wavelength and the optical power to provide a driving current, and a multiplexer multiplexing outputs from the plurality of laser diodes to be provided as the pumping light to the mode-locked fiber laser.

This pumping light generator controls a driving current for one or more laser diodes corresponding to the number of wavelengths and the optical power, thereby enabling the power of the pumping light for the mode-locked fiber laser or the erbium-doped fiber to be changed.

Also, another aspect of an optical transmission apparatus according to the present invention comprises: a spectrum analyzer detecting a number of wavelengths of an output light to an optical transmission line and an optical power of each of the wavelengths; a mode-locked fiber laser of a fixed optical power outputting type connected to a highly nonlinear fiber; a controller controlling a power of a super continuum light outputted from the highly nonlinear fiber at a fixed optical power so as to confine the number of wavelengths and the optical power within predetermined ranges; and a coupler coupling an output light of the controller and the output light to the optical transmission line.

In this case, the output optical power of the mode-locked fiber laser is fixed, and the controller controls the super continuum light of a fixed optical power outputted from the highly non linear fiber so that the number of wavelengths and the optical power are confined within predetermined ranges.

The controller in this case may control an attenuation of an optical power of each of the wavelengths so as make the number of wavelengths larger than that of the signal light and remove wavelength components corresponding to the signal light.

As described above, with the optical transmission apparatus according to the present invention, it becomes unnecessary to perform the ASE compensation control that has been conventionally performed in order to improve the optical SN deterioration resulting from a large ratio of ASE light to the signal light in the presence of a small number of wavelengths. Also, it is made possible to improve the speed of the initial start-up of the apparatus and the transmission characteristic stability in the presence a small number of wavelengths. Moreover, it becomes possible to make signal disconnections without fail in the presence of a small number of wavelengths, thereby rendering an effect of increasing the safety of the apparatus.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a diagram for illustrating a principle of an optical transmission apparatus according to the present invention;

FIG. 2 is a block diagram showing an embodiment [1] of an optical transmission apparatus according to the present invention;

FIG. 3 is a block diagram showing an arrangement of a controller in an embodiment [1] of the present invention;

FIG. 4 is a waveform diagram showing a principle of a control example (1) of an embodiment [1] of the present invention;

FIGS. 5A and 5B are diagrams showing a flowchart and a monitored waveform of the control example (1) of an embodiment [1] of the present invention;

FIG. 6 is a waveform diagram showing a principle of a control example (2) of an embodiment [1] of the present invention;

FIGS. 7A and 7B are diagrams showing a waveform monitored by a spectrum analyzer of a control example (2) of an embodiment [1] of the present invention;

FIGS. 8A and 8B are flowcharts of the control example (2) of an embodiment [1] of the present invention;

FIG. 9 is a block diagram showing an embodiment [2] of an optical transmission apparatus according to the present invention;

FIG. 10 is a flowchart of a control of an embodiment [2] of the present invention;

FIG. 11 is a block diagram showing an embodiment [3] of an optical transmission apparatus according to the present invention;

FIG. 12 is a flowchart of a control of an embodiment [3] of the present invention;

FIG. 13 is a block diagram showing an arrangement of a prior art optical transmission apparatus; and

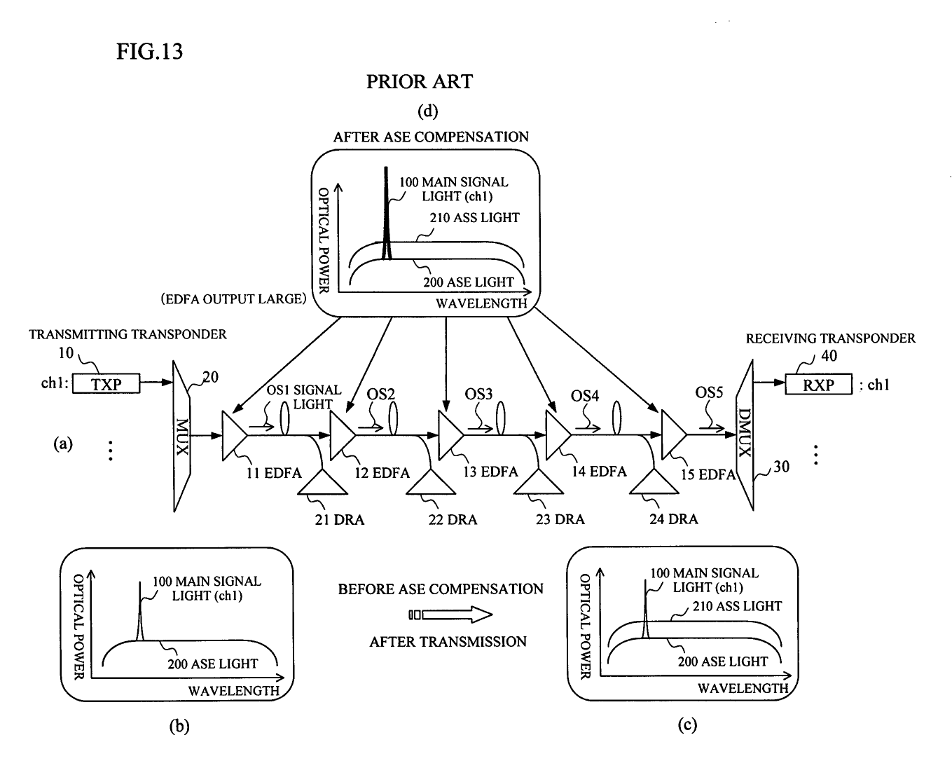

FIGS. 14A and 14B are graphs for illustrating a problem in a case of detecting a main signal light disconnection in the prior art technology.

### DESCRIPTION OF THE EMBODIMENTS

### Embodiment [1]

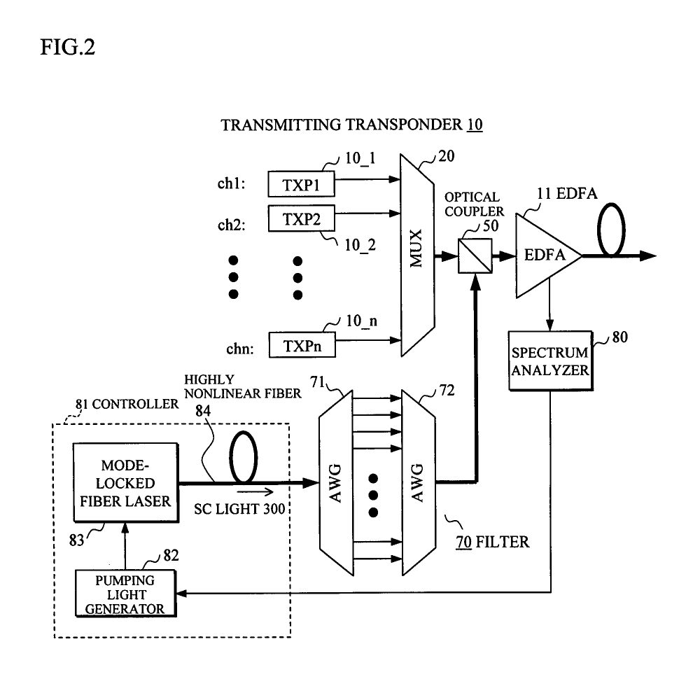

### FIGS. 2-4, 5A, 5B, 6, 7, 8A, 8B, and 9

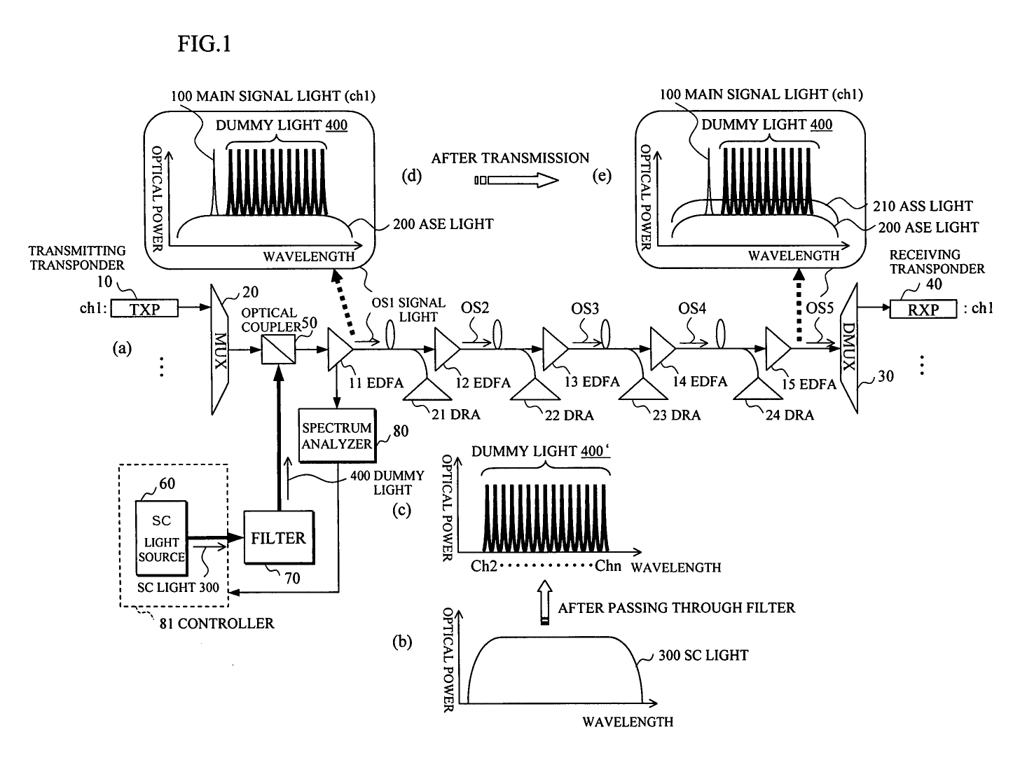

FIG. 2 shows an embodiment [1] of an optical transmission apparatus according to the present invention whose principle is shown in FIG. 1, and specifically shows an arrangement for coupling the dummy light 400 to the optical coupler 50 in FIG. 1.

Namely, in this embodiment [1], while a series circuit composed of a spectrum analyzer 80, a controller 81, and a filter 70 is provided as shown in FIG. 1 in order to generate a dummy light 400, the controller 81 is provided with a pumping light generator 82 for receiving an output of the spectrum analyzer 80, a mode-locked fiber laser 83 for changing an optical power of the super continuum light by receiving a pumping light from the pumping light generator 82, and a highly nonlinear fiber 84. The mode-locked fiber laser 83 and the highly nonlinear fiber 84 form the super continuum light source 60 shown in FIG. 1. Also, the filter 70 is a pair of arrayed waveguide gratings (AWGs) connected between the highly nonlinear fiber 84 and the optical coupler 50.

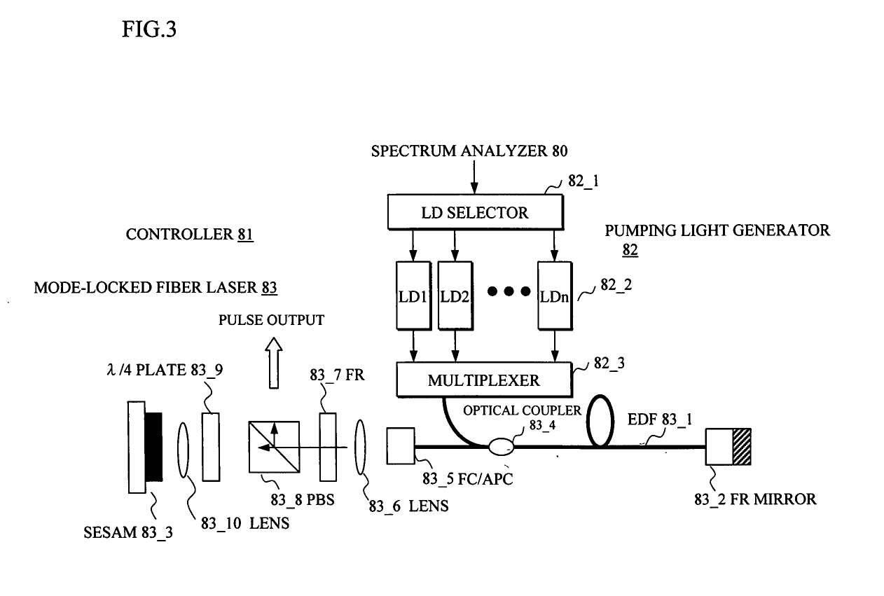

An arrangement of the above-mentioned controller 81 is specifically shown in FIG. 3. In this arrangement, the pumping light generator 82 is provided with a plural number “n” units of laser diodes (LD1-LDn) 82_2, an LD selector 82_1 for selecting one or more laser diodes 82_2, and a multiplexer 82_3 for multiplexing outputs of the laser diodes 82_2.

Also, the mode-locked fiber laser 83 has a resonator composed of the erbium-doped fiber (EDF) 83_1, a Faraday rotator mirror (FR mirror) 83_2, and a semiconductor saturable absorber mirror (SESAM) 83_3. A collimator (FC/APC) 83_5, a lens 83_6, a Faraday rotator (FR) 83_7, a Polarizing Beam Splitter (PBS) 83_8, a λ/4 plate 83_9, and a lens 83_10 are inserted between the EDF 83_1 and the SESAM 83_3, thereby extracting a pulse output from the PBS 83_8 to be transmitted to the highly nonlinear fiber 84 in order to generate a super continuum light (SC light).

An optical coupler 83_4 is provided between the EDF 83_1 and the collimator 83_5 of this mode-locked fiber laser 83, in which the output light from the multiplexer 82_3 of the pumping light generator 82 is injected in the form of a pumping light.

Namely, by injecting the pulse outputted by the mode-locked fiber laser 83 into the highly nonlinear fiber 84, a spectrum is spread to an ultrawideband to assume an SC light by a nonlinear effect arising in the highly nonlinear fiber 84, so that a practical light source of a high brightness and in the ultra wideband with minimum output from the optical fiber is realized.

Also, a mode-lock of the mode-locked fiber laser 83 can be obtained by applying a modulation of an integral multiplication of a basic cyclic frequency determined by the length of the resonator from the FR mirror 83_2 to the SESAM 83_3. As a method of such a modulation of the integral multiplication, a nonlinear polarization rotation may be used, or an electrooptic modulator or an acoustooptical modulator or the like may be used.

### CONTROL EXAMPLE (1)

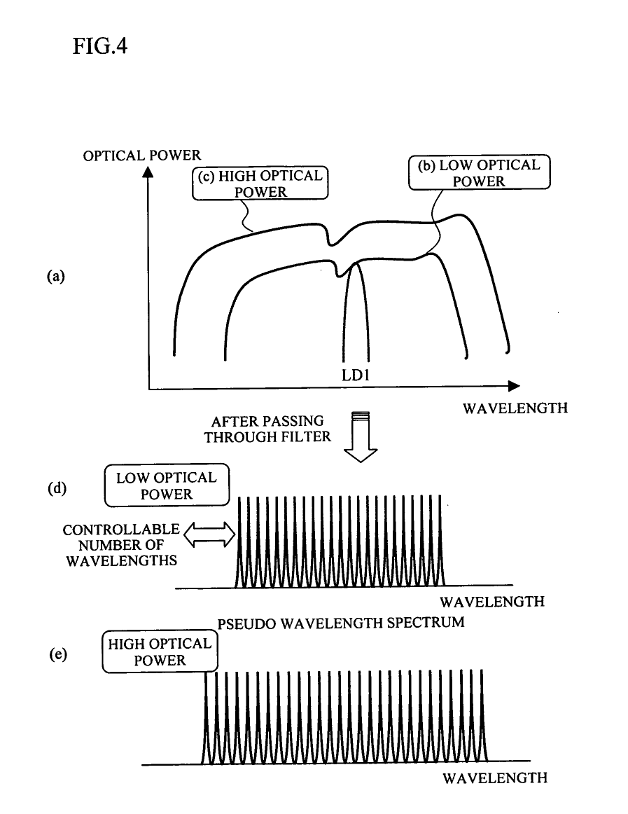

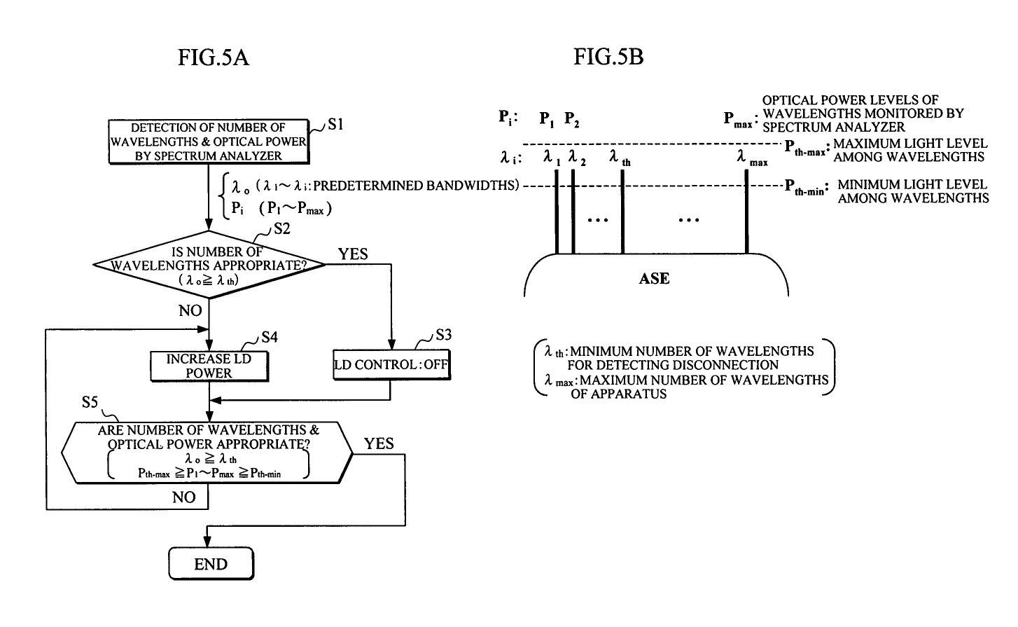

### FIGS. 4, 5A, and 5B

FIG. 4 shows a principle of a control example (1) of the embodiment [1]. It is to be noted that this example shows a case where the LD selector 82_1 selects only one laser diode LD1 in the pumping light generator 82.

The mechanism of generating the SC light is closely related to a nonlinear optical effect and a dispersion effect in the optical fiber, where it is known that a bandwidth of the SC light changes according to the optical power of a pulse from the mode-locked fiber laser to the highly nonlinear fiber (see a portion (a) of FIG. 4).

As seen from the above, when the optical output power of the mode-locked fiber laser 83 is low (see a portion (b) of FIG. 4) the pseudo wavelength spectrum after having passed through the filter 70 has a small number of wavelengths as shown in a portion (d) of FIG. 4 where the wavelength bandwidth of the SC light is narrow, while when the optical output power is increased (see a portion (c) of FIG. 4) the number of wavelengths increases as shown in a portion (e) of FIG. 4 and the wavelength bandwidth of the SC light becomes wide.

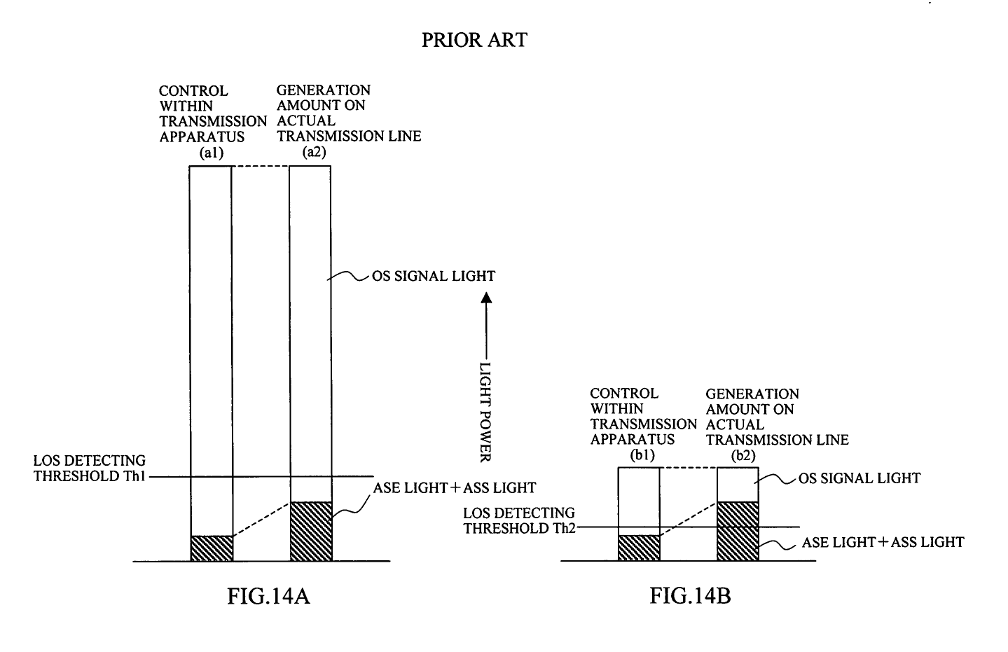

Therefore, by utilizing such a wavelength bandwidth control of the SC light to increase the number of wavelengths, even if the number of wavelengths of the main signal light is small as shown in FIG. 1, the number of wavelengths on the optical transmission line can be compensated so that the optical power is increased and the problem of the signal light disconnection threshold shown in FIG. 14B is eliminated.

FIG. 5A shows an operation flowchart of the embodiment [1] of FIG. 2 when such a control example (1) is applied. Namely, the spectrum analyzer 80 detects the number of wavelengths λₒ (wavelengths λ₁-λᵢ (i=1−max)) included in the output light of the EDFA 11 and the optical powers P₁-Pᵢ (i=1−max) of the wavelengths λ₁-λᵢ (at step S1). The LD selector 82_1 in the pumping light generator 82 determines whether or not the number of wavelengths λₒ is appropriate, namely whether or not λₒ≧λₜₕ (at step S2). It is to be noted that the λₜₕ is the minimum number of wavelengths required for light disconnection detection. As a result, when it is found that the number of wavelengths is appropriate, the LD selector 82_1 does not perform control for the laser diode 82_2 (at step S3). Normally, the detected number of wavelengths λₒ does not exceed the maximum number of wavelengths λₘₐₓ of the apparatus shown in FIG. 5B. However, when an abnormal case where λₒ≧λₘₐₓ is supposed, the driving current may be decreased so that the output of the laser diode 82_2 is decreased.

On the other hand, when it is found that the number of wavelengths is not appropriate (λₒ<λₜₕ), the LD selector 82_1 selects one laser diode LD1 from the “n” units of laser diodes 82_1 (see the portion (a) of FIG. 4), and increases the driving current so as to increase the output power (at step S4).

After having thus increased the optical power of the laser diode LD1, the number of wavelengths λₒ and the optical powers P₁-Pᵢ of the wavelengths λ₁-λᵢ detected again by the spectrum analyzer 80 are determined again as to whether or not they are appropriate (at step S5). This is done by determining whether or not both of λₒ≧λₜₕ and Pₜₕ₋ₘₐₓ≧P₁-Pᵢ≧Pₜₕ₋ₘᵢₙ are held. It is to be noted that as shown in FIG. 5B, Pₜₕ₋ₘₐₓ indicates the maximum optical level of the wavelengths and Pₜₕ₋ᵢₙ indicates the minimum optical level of the wavelength.

As a result, when it is found that the number of wavelengths λₒ and the optical powers P₁-Pᵢ are appropriate, the routine is ended. Otherwise, the process returns to step S4 to increase the optical output power of the laser diode LD1.

Thus, the optical output power of the laser diode LD1 is increased until the number of wavelengths and the optical power are determined to be appropriate at step S5. In the example shown, steps S4-S5 are repeated until the optical power finally assumes Pᵢ=Pₘₐₓ.

By thus changing the optical power of the pumping light generator 82, the SC light 300 outputted through the mode-locked fiber laser 83 and the highly nonlinear fiber 84 is provided to the filter 70 in the form where the number of wavelengths is controlled as shown in the portions (b) and (c) of FIG. 4.

In this filter 70, as a result of the increase of the optical power as shown in the portion (c) of FIG. 4, for example, a part of the number of wavelengths (wavelength bandwidth) occasionally includes the wavelength bandwidth of the signal light outputted from the wavelength multiplexer 20. Therefore, since this wavelength bandwidth is preliminarily known and can be removed by the filter 70, the output light where the main signal light 100 and the dummy light 400 are combined in a state in which they do not overlap with each other is outputted from the optical coupler 50 to be provided to the EDFA 11. It is to be noted that the AWG 71 of the filter 70 composes the demultiplexer of the wavelength components of the SC light 300 inputted, and the AWG 72 composes a multiplexer thereof.

### CONTROL EXAMPLE (2)

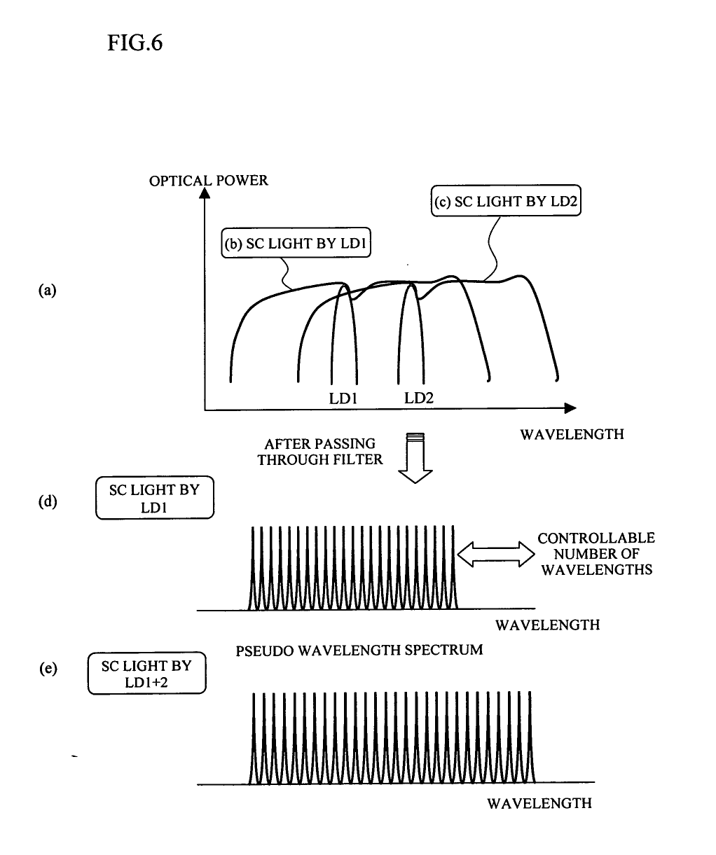

### FIGS. 6, 7A, 7B, 8 A, and 8B

FIG. 6 shows a control example (2) of the embodiment [1]. While in the above-mentioned control example (1), the optical power is changed by controlling a single laser diode LD1 as shown in the portion (a) of FIG. 4, in this control example (2), a plurality of laser diodes (i.e. two laser diodes LD1 and LD2), are selected and the number of wavelengths of the dummy light is increased by these laser diodes.

Namely, when the LD selector 82_1 of the pumping light generator 82 selects two laser diodes LD1 and LD2 according to the output (number of wavelengths and optical power) of the spectrum analyzer 80, the optical power characteristic of the SC light of the laser diode LD1 exhibits a portion (b) of FIG. 6, and exhibits a pseudo wavelength spectrum shown in a portion (d) of FIG. 6 after having passed through the filter 70. Likewise, the SC light of the laser diode LD2 provides the characteristic of a portion (c) of FIG. 6, so that the pseudo wavelength spectrum of the SC light with both spectra of the laser diodes LD1 and LD2 having been overlapped exhibits a characteristic as if the pseudo wavelength spectra of the laser diodes LD1 and LD2 are combined as shown in a portion (e) of FIG. 6.

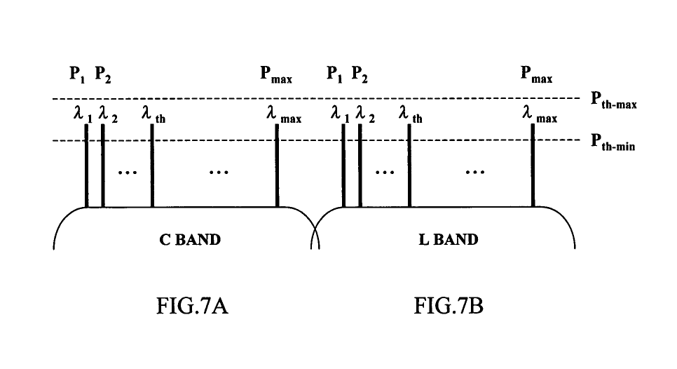

FIGS. 7A and 7B show a waveform of the control example (2) monitored by the spectrum analyzer 80. The C band of FIG. 7A indicates the waveform by the laser diode LD1 shown in the portion (b) of FIG. 6 and the L band shown in FIG. 7B indicates the wavelength by the laser diode LD 2 shown in the portion (c) of FIG. 6. The others are the same as the waveform diagram shown in FIG. 5B.

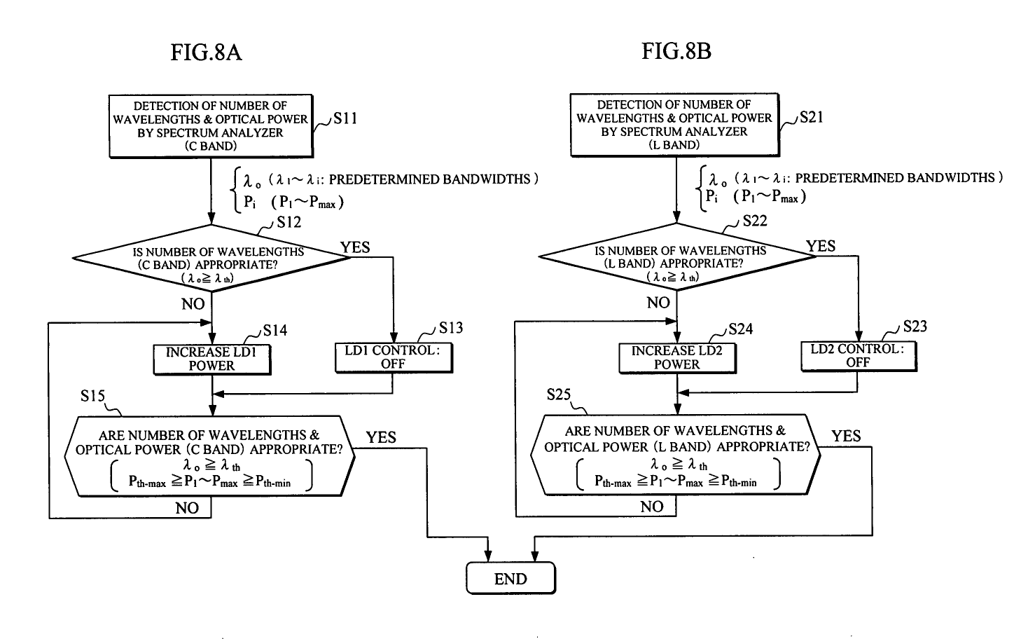

A flowchart of such a control example (2) is shown in FIGS. 8A and 8B. The flowchart of FIG. 8A shows the control for the C band by the laser diode LD1, where steps S11-S15 correspond to steps S1-S5 of FIG. 5A. Also, the flowchart of FIG. 8B shows the control for the L band by the laser diode LD 2, where steps S21-S25 correspond to steps S1-S5 of FIG. 5A.

Namely, in the C band control shown in FIG. 8A, the number λₒ of wavelengths of laser diode LD1 and the optical powers P₁-Pᵢ (finally P₁-Pₘₐₓ) of the wavelengths are controlled to assume appropriate values. Likewise in FIG. 8B, in order to control the L band, the number of wavelengths λₒ of the laser diode LD 2 and the optical powers P₁-Pᵢ (finally P₁-Pₘₐₓ) of the wavelengths are controlled to assume appropriate values. It is to be noted that the other processings are the same as the flowchart of control example (1) shown in FIG. 5A.

When the laser diode LD1 covers the wavelength bandwidth of C band and the laser diode LD2 covers the wavelength bandwidth of L band, all of the bandwidth of the C band and the L band can be thus covered by controlling both of the laser diodes LD1 and LD2.

### Embodiment [2]

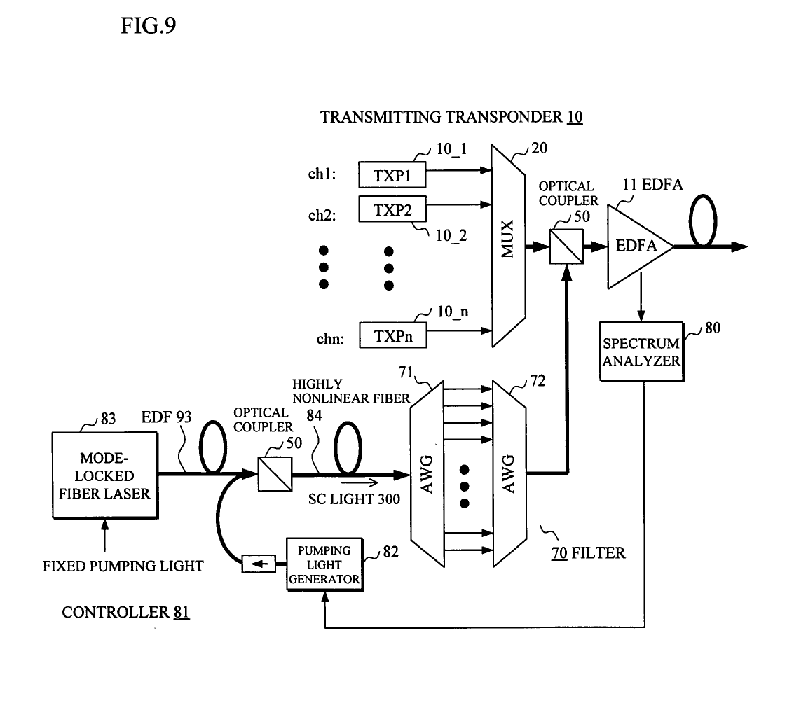

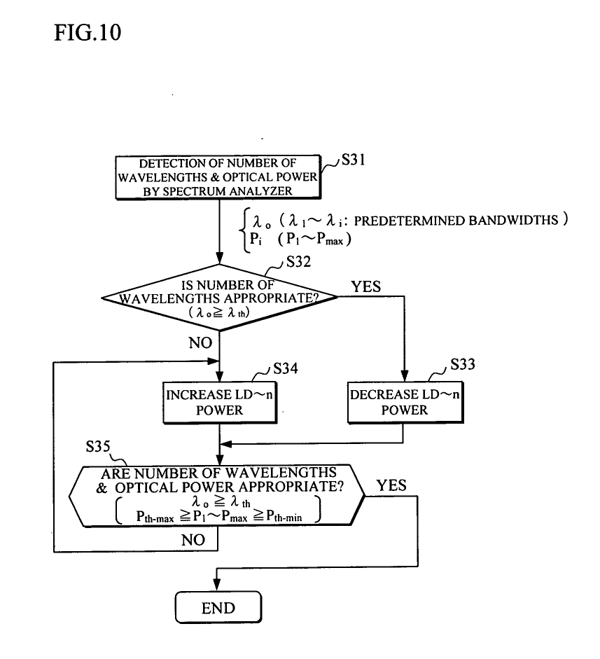

### FIGS. 9 and 10

This embodiment is different from the above-mentioned embodiment [1] in that the optical coupler 50 and an EDF 93 are inserted between the mode-locked fiber laser 83 and the highly nonlinear fiber 84 in the controller 81, and the pumping light is injected into the optical coupler 50 by connecting the pumping light generator 82 thereto. The mode-locked fiber laser 83 in this embodiment is a fixed output type by the fixed pumping light.

The control flow of the embodiment [2] is shown in FIG. 10. Steps S31-S35 in this control flow basically correspond to steps S1-S5 in FIG. 5A, so that the processings are the same as those for controlling a single laser diode LD1. However, at step S34, the optical output level of at least one of the laser diodes LD1-LDn is increased and provided to the optical coupler 50 to be coupled with the output light of the EDF 93. This is the same as the control example (2) in the above-mentioned embodiment [1]. At this time, the fixed optical output power from the mode-locked fiber laser EDF 93 undergoes the Raman amplification effect by the EDF 93, whereby the input power to the highly nonlinear fiber 84 is controlled.

### Embodiment [3]

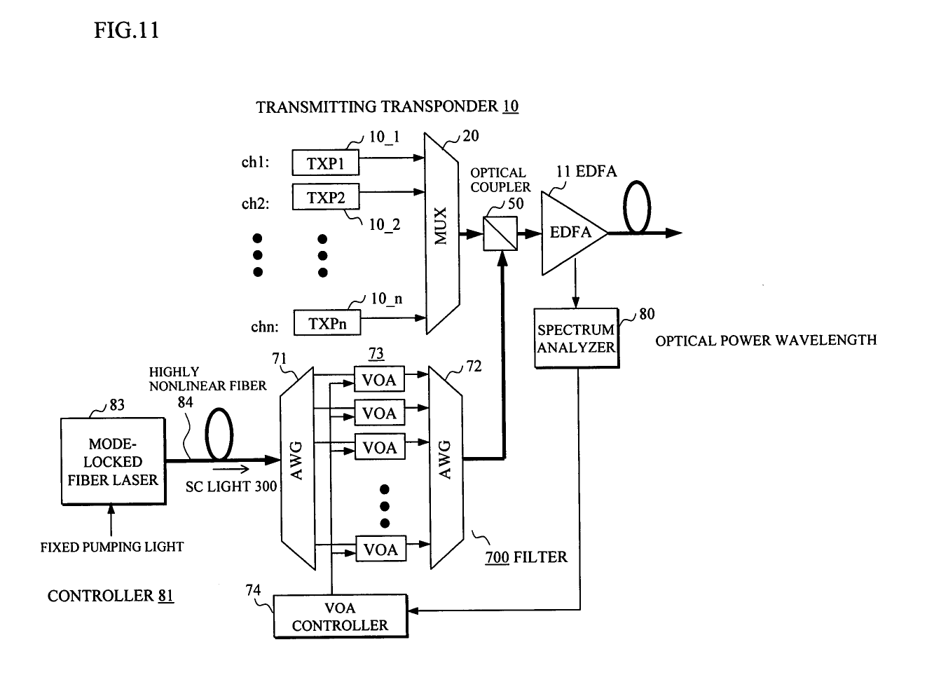

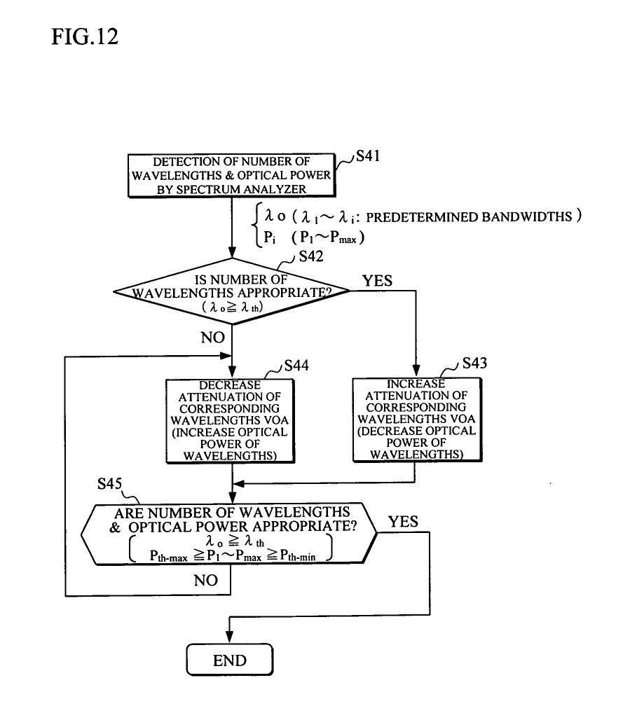

### FIGS. 11 and 12

In this embodiment [3], the controller 81 is composed of the mode-locked fiber laser 83 and the highly nonlinear fiber 84, and a pumping light generator is not used as in the above-mentioned embodiments [1] and [2]. Instead, a filter 700 and a VOA controller 74 are used to form the controller. The filter 700 is different in that variable optical attenuators (VOAs) 73 are further provided between the AWGs 71 and 72 corresponding to “n” units of channels ch1-chn in the transmitting transponder 10, and that the variable optical attenuators (VOA) 73 are controlled by a VOA controller 74.

The control flow of this embodiment [3] is shown in FIG. 12. Also in this control flow, the steps S41-S45 basically correspond to steps S1-S5 in FIG. 5A. However, it is different in that the bandwidth of the SC light 300 outputted from the mode-locked fiber laser 60 through the highly nonlinear fiber 84 is controlled by reducing or increasing the optical power of the corresponding wavelength at step S43 or S44. Therefore, the number of wavelengths (pseudo wavelength bandwidth) can be controlled corresponding to an arbitrary number of wavelengths of the main signal at step S43 or S44.

It is to be noted that an optical switch or a semiconductor optical amplifier (SOA) can be substituted for the variable optical attenuator (VOA) for controlling the optical level of the individual wavelength.

It is to be noted that the present invention is not limited by the above-mentioned embodiments, and it is obvious that various modifications may be made by one skilled in the art based on the recitation of the claims.

What is claimed is:

1. An optical transmission apparatus comprising:
a detector detecting a number of wavelengths of an output light to an optical transmission line and an optical power of each of the wavelengths;
a controller controlling an optical power outputted from a source of a super continuum light so as to confine the number of wavelengths and the optical power within predetermined ranges;
a filter removing a wavelength component corresponding to a signal light from the super continuum light; and
a coupler coupling an output light of the filter and the output light to the optical transmission line.

2. The optical transmission apparatus as claimed in claim 1, wherein the controller comprises a highly nonlinear fiber, a mode-locked fiber laser generating the super continuum light by providing an optical pulse to the highly nonlinear fiber, and a pumping light generator providing the mode-locked fiber laser with a pumping light through an optical coupler based on the number of wavelengths and the optical power.

3. The optical transmission apparatus as claimed in claim 1, wherein the controller comprises a highly nonlinear fiber, a mode-locked fiber laser of a fixed optical power outputting type generating the super continuum light of a fixed optical power by providing an optical pulse to the highly nonlinear fiber, an erbium-doped fiber connected between the mode-locked fiber laser and the highly nonlinear fiber, and a pumping light generator providing the erbium-doped fiber with a pumping light through an optical coupler based on the number of wavelengths and the optical power.

4. The optical transmission apparatus as claimed in claim 2, wherein the pumping light generator comprises a plurality of laser diodes, a selector selecting at least one of the laser diodes based on the number of wavelengths and the optical power to provide a driving current, and a multiplexer multiplexing outputs from the plurality of laser diodes to be provided as the pumping light to the mode-locked fiber laser.

5. An optical transmission apparatus comprising:
a spectrum analyzer detecting a number of wavelengths of an output light to an optical transmission line and an optical power of each of the wavelengths;
a mode-locked fiber laser of a fixed optical power outputting type connected to a highly nonlinear fiber;
a controller controlling a power of a super continuum light outputted from the highly nonlinear fiber at a fixed optical power so as to confine the number of wavelengths and the optical power within predetermined ranges; and
a coupler coupling an output light of the controller and the output light to the optical transmission line.

6. The optical transmission apparatus as claimed in claim 5, wherein the controller comprises a filter extracting wavelength components of the super continuum light from the highly nonlinear fiber, and means controlling an attenuation of an optical power of each of the wavelengths outputted from the filter so as to provide a larger number of wavelengths than a signal light and remove wavelength components.

7. The optical transmission apparatus as claimed in claim 1, wherein the predetermined ranges comprise a range where the number of wavelengths is equal to or more than a minimum number of wavelengths for detecting a loss of light, and a range where the optical power is between a maximum and minimum optical level of each of the wavelengths.

8. The optical transmission apparatus as claimed in claim 3, wherein the pumping light generator comprises a plurality of laser diodes, a selector selecting at least one of the laser diodes based on the number of wavelengths and the optical power to provide a driving current, and a multiplexer multiplexing outputs from the plurality of laser diodes to be provided as the pumping light to the mode-locked fiber laser.

9. The optical transmission apparatus as claimed in claim 5, wherein the predetermined ranges comprise a range where the number of wavelengths is equal to or more than a minimum number of wavelengths for detecting a loss of light, and a range where the optical power is between a maximum and minimum optical level of each of the wavelengths.
